(19) United States
(12) Patent Application Publication
(10) Pub. No.: US 2017/0106559 A1
(43) Pub. Date: Apr. 20, 2017

(54) FENCE ASSEMBLY FOR MITER SAW

(71) Applicant: REXON INDUSTRIAL CORP., LTD., Taichung (TW)

(72) Inventors: Teng-Sen LEE, Taichung (TW); Hung Jung CHIANG, Taichung (TW)

(21) Appl. No.: 15/293,343

(22) Filed: Oct. 14, 2016

(30) Foreign Application Priority Data
Oct. 15, 2015 (TW) 104133929

(51) Int. Cl. B27B 27/06; B23D 45/02

(52) U.S. Cl. CPC B27B 27/06; B23D 45/024

(57) ABSTRACT

A fence assembly for miter saw includes a mounting base mounted at a supporting base and defining a first abutting surface that extends perpendicular to a first work surface of the supporting frame, and a fence unit selectively mountable at the mounting base in a first position or second position and defining a second abutting surface, which is disposed perpendicular to the first work surface and co-planar with the first abutting surface when the fence unit is set in the first position, or perpendicular to the first work surface in a non-coplanar manner relationship with the first abutting surface when the fence unit is set in the second position. Thus, changing the position of the fence unit achieves an increase in the cutting stroke.

### BACKGROUND OF THE INVENTION

1. Field of the Invention

The present invention relates to miter saw technology and more particularly, to a fence assembly for use in a miter saw.

2. Description of the Related Art

When using a miter saw to cut a workpiece, the user will place the workpiece on the worktable to abut the workpiece against a fence, enabling the workpiece to be supported in position by the fence and avoiding displacement of the workpiece during the cutting operation.

In a conventional miter saw, the fence is affixed to the supporting base and not adjustable to change the position according to actual cutting requirements. Subject to the limitation of the position of the fence, the saw arm can simply be moved within a predetermined stroke, resulting in a limitation on the cutting stroke.

### SUMMARY OF THE INVENTION

The present invention has been developed in view of the prior art limitations. It is one of the objects of the present invention to provide a fence assembly for a miter saw, which allows adjustment of the position of the fence according to actual cutting requirements to solve the problem of a limited cutting stroke.

To achieve this and other objects of the present invention, a fence assembly comprises a mounting base and a fence unit. The mounting base is mounted on a supporting base of a miter saw, defining a first abutment surface that extends perpendicular to a first work surface of the supporting base. The fence unit is mounted at the mounting base and movable back and forth relative to the mounting base between a first position and a second position. Further, the fence unit defines a second abutting surface. The second abutting surface is disposed perpendicular to the first work surface and coplanar with the first abutting surface of the mounting base when the fence unit is in the first position. The second abutting surface is disposed perpendicular to the first work surface in a non-coplanar manner relative to the first abutting surface when the fence unit is in the second position.

Thus, the position of the fence unit of the fence assembly can be adjusted according to the actual cutting requirements for the miter saw. When the fence unit is set in the first position, a saw arm of the miter saw can maintain its original cutting stroke. When the fence unit is set in the second position, the gap between the second abutting surface of the fence unit and the first abutting surface of the mounting base is used to increase the cutting stroke of the saw arm of the miter saw.

Other and further advantages and features of the present invention will be understood by reference to the following specification in conjunction with the accompanying drawings.

### BRIEF DESCRIPTION OF THE DRAWINGS

FIG. 1 is perspective view, illustrating a fence assembly incorporated on a miter saw worktable in accordance with the present invention.

FIG. 2 is an exploded view of the fence assembly in accordance with the present invention.

FIG. 3 is a schematic side view of the present invention, illustrating the fence unit in the first position.

FIG. 4 is similar to FIG. 3, illustrating the fence unit in the second position.

### DETAILED DESCRIPTION OF THE INVENTION

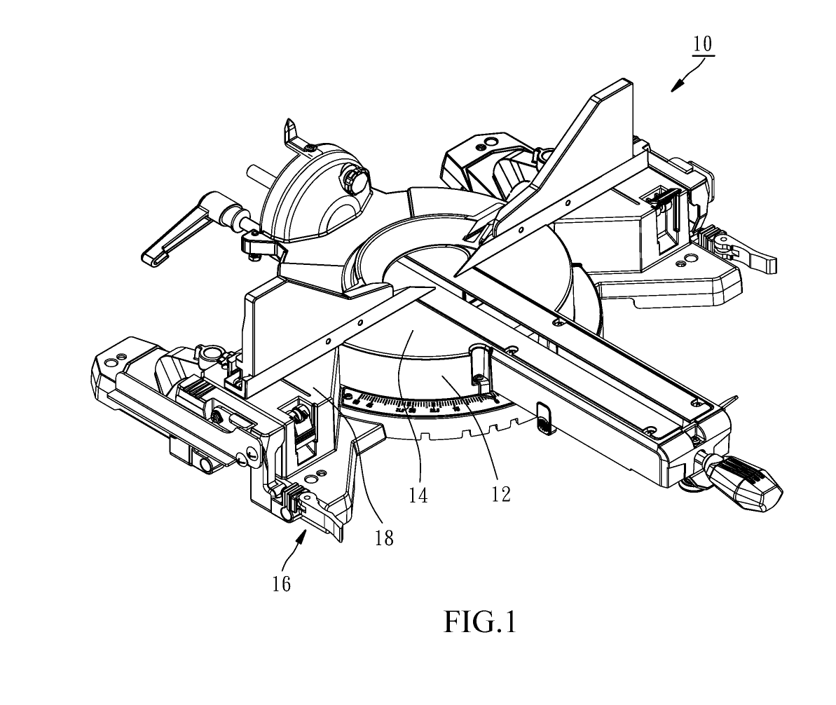

Referring to FIG. 1, a fence assembly 10 in accordance with the present invention is shown used in a miter saw that comprises a supporting base 16, and a worktable 12 rotatably supported on the supporting base 16. The supporting base 16 comprises a first work surface 18. The worktable 12 comprises a second work surface 14 coplanar with the first work surface 18. The first work surface 18 and the second work surface 14 are adapted for supporting a workpiece (not shown). Because the miter saw (not shown) is of the known machine tool and not within the scope of the present invention and in order to save space, the structural details and operating principle of the miter saw (not shown) will not be discussed here.

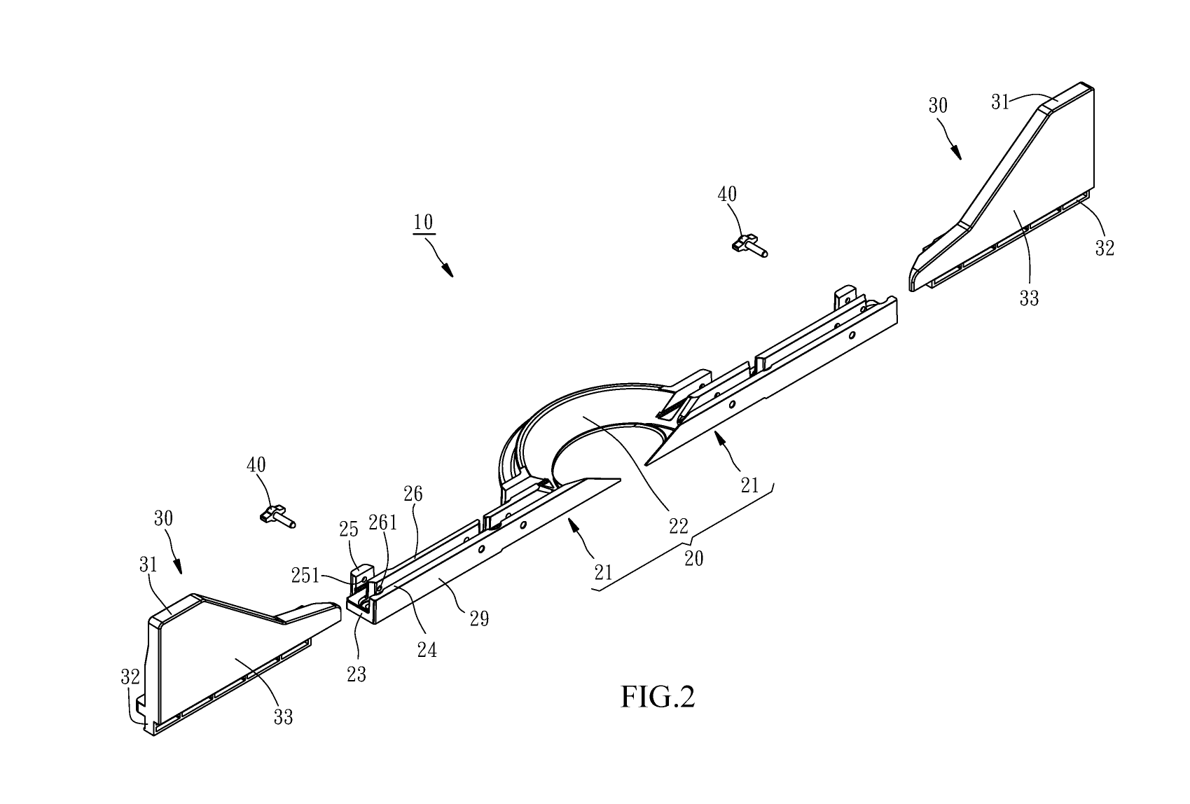

Referring to FIG. 2, the fence assembly 10 comprises a mounting base 20 and two fence units 30.

The mounting base 20 is affixed, e.g., attached by bolting, screwing, welding, gluing, or other means as known in the art, to the supporting base 16 and bridges over the second work surface 14 of the worktable 12, comprising two mounting parts 21 and an arched connection part 22 connected between the two mounting parts 21. Each mounting part 21 defines a bottom wall 23, a first upright wall 24, a second upright wall 25 and a third upright wall 26. The first upright wall 24, the second upright wall 25 and the third upright wall 26 are respectively connected to the bottom wall 23, for example, connected to a top surface or a side surface of the bottom wall. Further, the third upright wall 26 is disposed between the first upright wall 24 and the second upright wall 25. Thus, a first retaining groove 27 and a second retaining groove 28 are respectively defined between the bottom wall 23 and the first upright wall 24 and third upright wall 26 and between the bottom wall 23 and the second upright wall 25 and third upright wall 26. Further, the first upright wall 24 defines a first abutting surface 29 that extends perpendicular to the first work surface 18. The second upright wall 25 defines therein a screw hole 251. The screw hole 251 has two opposite ends thereof respectively disposed in communication with the outside space and the second retaining groove 28. The third upright wall 26 defines therein a locating hole 261. The locating hole 261 has two opposite ends thereof respectively disposed in communication with the first retaining groove 27 and the second retaining groove 28.

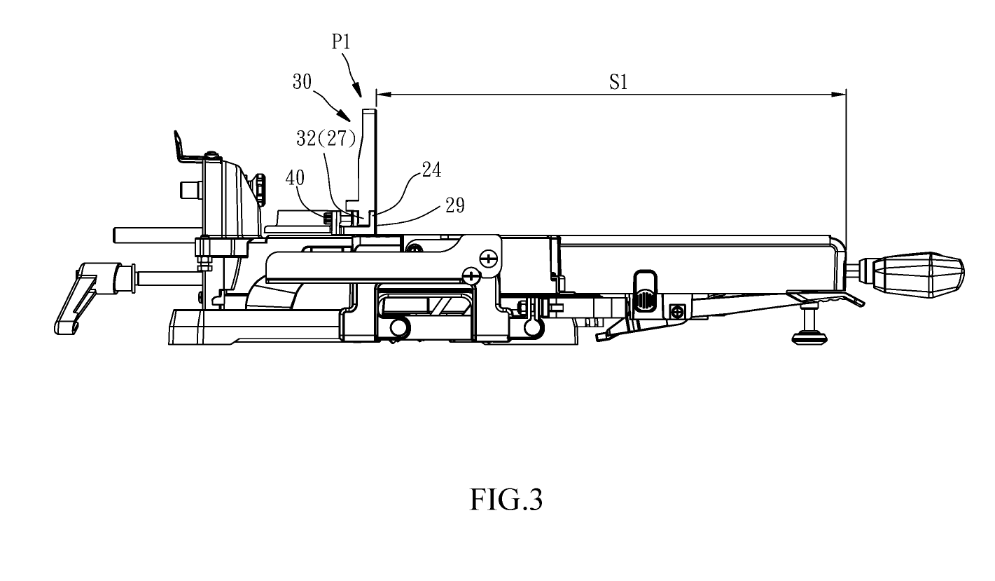

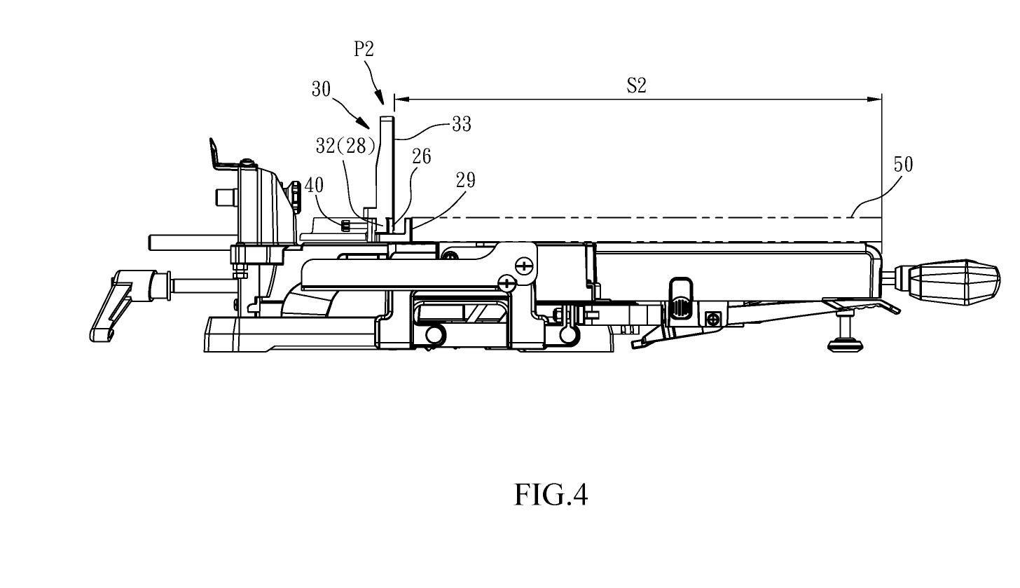

Each fence unit 30 comprises an abutment portion 31 and an engaging portion 32. The abutment portion 31 defines a second abutting surface 33. The engaging portion 32 is connected to a bottom side of the abutment portion 31 and selectively engageable into the first retaining groove 27 or the second retaining groove 28 of the mounting base 20. When the fence unit 30 is in a first position P1, as shown in FIG. 3, the engaging portion 32 of the fence unit 30 is engaged into the first retaining groove 27 of the mounting base 20. At this time, the second abutting surface 33 of the fence unit 30 is coplanar with the first abutting surface 29 of the mounting base 20. When the fence unit 30 is in a second position P2, as shown in FIG. 4, the engaging portion 32 of the fence unit 30 is engaged into the second retaining groove 28 of the mounting base 20. At this time, the second abutting surface 33 of the fence unit 30 is not coplanar with the first abutting surface 29 of the mounting base 20.

As shown in FIGS. 2-4, when the fence unit 30 is set in the first position P1, a locking member 40 (for example, lock screw bolt) is installed to lock the fence unit 30 in the first position P1. At this time, the locking member 40 is threaded into the screw hole 251 with the distal end thereof fitted into the locating hole 261, enabling the engaging portion 32 of the fence unit 30 to be forced by the third upright wall 26 of the mounting base 20 to abut against the first upright wall 24 of the mounting base 20 tightly. When the fence unit 30 is set in the second position P2, the same locking member 40 (lock screw bolt) is installed to lock the fence unit 30 in the second position P2. At this time, the locking member 40 is threaded into the screw hole 251 with the distal end thereof stopped against the engaging portion 32 of the fence unit 30, forcing the engaging portion 32 of the fence unit 30 to abut against the third upright wall 26 of the mounting base 20 tightly. Additionally, additional locking members can be used threaded in additional holes along the mounting base.

Thus, when the user sets the fence unit 30 in the first position P1, the first abutting surface 29 of the mounting base 20 and the second abutting surface 33 of the fence unit 30 provide positive support to the workpiece. At this time, the saw arm maintains its original cutting stroke S1 (see FIG. 3). When the user sets the fence unit 30 in the second position P2, a gap is left between the second abutting surface 33 of the fence unit 30 and the first abutting surface 29 of the mounting base 20 due to backward displacement of the fence unit 30. The presence of this gap causes the cutting stroke of the saw arm to be changed from S1 to S2 (see FIG. 4). In other words, adjusting the position of the fence unit 30 can increase the cutting stroke of the saw arm. Further, in order to prevent the non-coplanar relationship between the first abutting surface 29 of the mounting base 20 and the second abutting surface 33 of the fence unit 30 from affecting the positioning stability of the workpiece to be cut when the fence unit 30 is set in the second position P2, the user can place a raiser block 50 on the worktable 12 and then place the workpiece on the raiser block 50, enabling the workpiece to be supported against the second abutting surface 33 of the fence unit 30. Further, the height of the raiser block 50 can be larger than or equal to the height of the first abutting surface 29 of the mounting base 20.

In conclusion, the fence assembly 10 of the present invention allows adjustment of the position of the fence unit according to actual cutting requirements so that the cutting stroke of the saw arm can be relatively adjusted, and thus, the design of the present invention can solve the problem of a limited cutting stroke of the prior art miter saw designs.

What is claimed is:

1. A fence assembly used in a miter saw comprising a supporting base and a worktable rotatably supported on said supporting base, said supporting base defining a first work surface, said worktable defining a second work surface, the fence assembly comprising:
a mounting base mounted on said supporting base, said mounting base comprising a first abutment surface perpendicular to said first work surface of said supporting base; and
at least one fence unit mounted on said mounting base and movable relative to said mounting base between a first position and a second position, each of said at least one fence unit comprising a second abutting surface, wherein when said fence unit is in said first position, said second abutting surface is disposed perpendicular to said first work surface and coplanar with said first abutting surface of said mounting base, and wherein when said fence unit is in said second position, said second abutting surface is disposed perpendicular to said first work surface in a non-coplanar manner relative to said first abutting surface.

2. The fence assembly as claimed in claim 1, wherein said mounting base comprises a mounting part, said mounting part comprising a bottom wall, a first upright wall, a second upright wall and a third upright wall, said first upright wall, said second upright wall and said third upright wall being respectively connected to said bottom wall, said third upright wall being spaced between said first upright wall and said second upright wall so that said bottom wall defines a first retaining groove between said first upright wall and said third upright wall and a second retaining groove between said second upright wall and said third upright wall; said first abutting surface is located on said first upright wall; wherein each of said at least one fence unit further comprises an engaging portion, said engaging portion being engageable into said first retaining groove when said fence unit is set in said first position, and said engaging portion engageable into said second retaining groove when said fence unit is set in said second position.

3. The fence assembly as claimed in claim 2, wherein said second upright wall of said mounting base comprises a screw hole, and a locking member threadable into said screw hole, said locking member having a distal end that is stoppable against said third upright wall when said at least one fence unit is set in said first position, or stoppable against said engaging portion of said fence unit when said fence unit is set in said second position.

4. The fence assembly as claimed in claim 1, further comprising a raiser block, said raiser block having a height higher than or equal to the height of said first abutting surface of said mounting base, said raiser block being placed on said first work surface of said supporting base and abutted against said first abutting surface of said mounting base when said at least one fence unit is set in said second position.
